(19) United States
(12) Patent Application Publication
(10) Pub. No.: US 2008/0020342 A1
(43) Pub. Date: Jan. 24, 2008

(54) Silicone-thermoplastic molded grillz

(75) Inventors: Kyung Tae Kim, Dallas, TX (US); Young Kim, Dallas, TX (US)

Correspondence Address: Kyung T. Kim;Suite 240, 3102 Maple Avenue, Dallas, TX, 75201, US

(73) Assignee: O.J. Trading, Inc., Dallas, TX (US)

(21) Appl. No.: 11/491,641

(22) Filed: Jul. 24, 2006

(51) Int. Cl. A61C 13/00; A61C 13/24

(52) U.S. Cl. 433/167; 433/188

(57) ABSTRACT

A decorative assembly consisting of various designed ornamental frames made of dentistry metal (gold, silver, chromium, cobalt, titanium, or similar metals) with outward plating of nickel free Rhodium and gold or silver imbedded with stone patterns and securing in place by tightening prongs a silicone-thermoplastic material insert member molded by temperature to fit a group of human teeth and held in place by a suction effect. The silicone-thermoplastic material allows the decorative assembly to be removed and reinserted as desired by the user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

In general, the invention relates to a method of applying a decorative frame of polished dentistry metal with stone patterns to human teeth for decoration and entertainment purposes by securing in place by tightening prongs a silicone-thermoplastic material member molded by heating to certain temperatures to fit a particular person's group of upper or lower teeth and held in place by a suction effect, but can be removed and reinserted as desired. The user would have a choice of various styles of metal frames and stone patterns.

2. Description of the Prior Art

The decorating of teeth or an entire denture of a human by adding or attaching some type of ornamental device to call attention or for entertainment purposes have become popular among certain people in the entertainment industry and people who desire to associate with certain types of social and cultural environments. Some decorative devices for human teeth consist of adhering a decorative element to a vestibule surface of a tooth or vestibule surfaces of a group of teeth in the form of a plate made of metal or plastic hereby producing an attraction on a user's teeth or by specially designed frames that fit over several teeth to hold in place a decoration fixed to the vestibule surface. See for example U.S. patent application Ser. No. 11/274,251

Using thermoplastic materials, mouth-guard assemblies to protect the teeth, gums and jaws during athletic events, such as football and hockey, are often used and commonly a required piece of equipment on the playing field, but the prior art concerns protecting the teeth from blows to a player's mouth that may loosen, break, or knock entirely loose one or more teeth. See for example U.S. Pat. Nos. 5,816,255, 3,211,143, 3,124,129, 3,073,300, 2,750,941 and 2,705,492 and U.S. patent application Ser. No. 10/232,240. The mouth-guard assembly is a prior art that is designed differently to protect teeth and is not a prior art that is designed to hold in place an assembly that is only to decorate teeth. Usually, the mouth-guard assemblies are designed to provide strength and rigidity that spread an impact or blow over all of the teeth and particularly rearwardly to the back teeth that are firmly anchored to the jaw.

The present invention is an individualized and customized method to hold an assembly for upper and lower teeth decoration on a removable basis. The present invention is placed into the mouth and with the user's teeth pressed into the silicone-thermoplastic material an exact mold of the user's teeth is created in the silicone-thermoplastic material. The thermoplastic material is moldable, settable and conforms to a user's intra-oral structures when subject to heat and bite pressure. The present invention does not have any application as a sports guard or as an orthodontic appliance. With the present invention, there are no risks to health or hygiene of the user's mouth, since the assembly can be easily removed at any time.

### BRIEF SUMMARY OF THE INVENTION

The present invention relates to a method for securing a decorative or ornamental frame made of dentistry metal with outward plating of nickel free Rhodium and silver or gold imbedded with stone patterns to a set of human teeth by utilizing a silicone-thermoplastic member inserted into the frame and held by tightening prongs.

The heated assembly is inserted into the mouth of the person being fitted and positioned to press into the desired set of teeth and thereby producing an accurate impression of the user's teeth. As the device cools to mouth temperatures or lower, the impression-taking material will harden and thereafter permanently retain the impression of the teeth so that the finished assembly may be removed and reinserted as desired.

### BRIEF DESCRIPTION OF THE SEVERAL VIEWS OF THE DRAWING

These and other objects of the present invention will become evident from the following illustrations:

FIG. 1 is a representation of the decorative frame with the outward adjustable prongs prior to any application of heating.

FIG. 2A is a representation of the silicone-thermoplastic member prior to any heat application and positioned with the perimeter lip edge down.

FIG. 2B is a representation of the silicone-thermoplastic member prior to any heat application and positioned with the perimeter lip edge up and an end view.

FIG. 2C is a representation of the silicone-thermoplastic member prior to any heat application and positioned with the perimeter lip edge up and illustrating the curvature.

FIG. 3 is a presentation of the decorative frame with the silicone-thermoplastic member inserted into the frame (complete assembly) prior to heat application.

FIG. 4 is a presentation of the complete assembly subsequent to heat application, teeth impression and cooling.

### DETAILED DESCRIPTION OF THE INVENTION

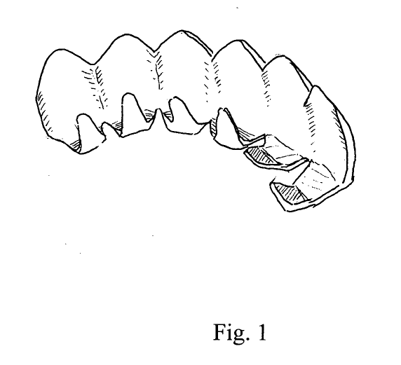

FIG. 1 illustrates the decorative and ornamental frame that the user initially adjusts to the shape of the user's upper and/or lower set of teeth prior to heat application and insertion of the silicone-thermoplastic material.

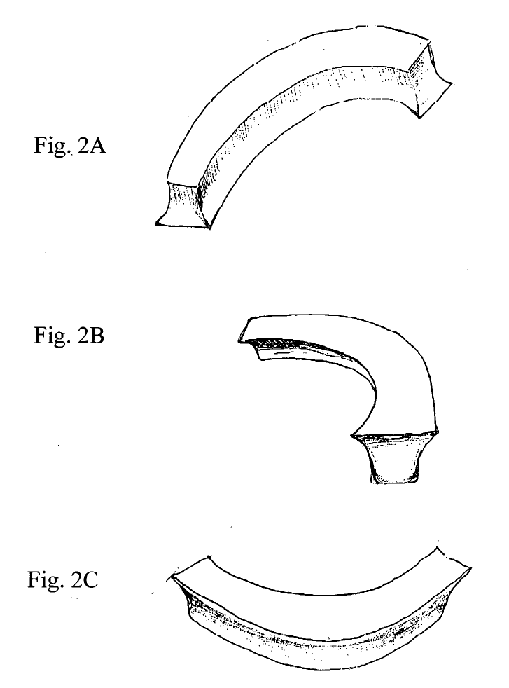

FIG. 2A, FIG. 2B and FIG. 2C illustrate the silicone-thermoplastic insert member, which is ¼ inches in height, ⅛ inches in top width, 1⅜ inches in inner length, 1⅝ inches in outer length and ⅜ inches in widest bottom width with the perimeter lip. The silicone member is designed to fit within either the upper teeth frame or the lower teeth frame with the thickness of the member not overly bulky.

The silicone insert member is constructed throughout of a single thermoplastic elastomeric composition of a suitable character of a high molecular weight polymer such that when the structure is heated to a suitable temperature, the walls thereof are softened sufficiently that they may be directly molded about the inner and outer surfaces of the teeth to provide a close interfitting about the tooth surfaces and which, upon cooling to normal temperatures, will be hardened sufficiently to retain a permanent accurate impression of the entire set of teeth, so that the assembly may be inserted and used repeatedly.

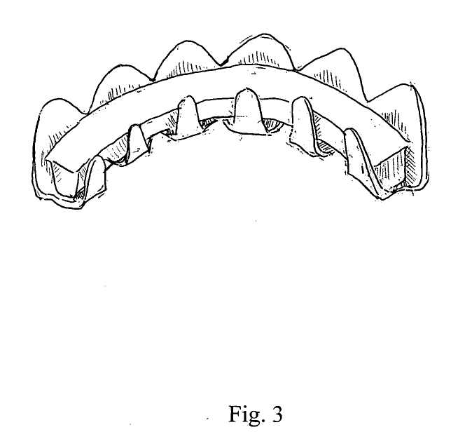

FIG. 3 illustrates the assembly of the silicone member positioned with the perimeter lip upward in the ornamental frame and the outer prongs or back hooks of the frame. The prongs are adjusted to lock in the silicone member by the user prior to heat application.

The silicone member and frame assembly is first prefitted to the user's mouth by shaping it to conform to the general shape of the teeth set.

Then, the assembly is heated by immersing in hot water to a desired softening temperature, which will change the silicone material from a non-transparent color to a transparent color. The silicone member will soften sufficiently to be molded about the teeth at a temperature in the range from about 120° F. to about 160° F. and which, upon cooling below this range of temperature and particularly to normal atmospheric or internal mouth temperatures, will permanently retain an accurate impression of the teeth.

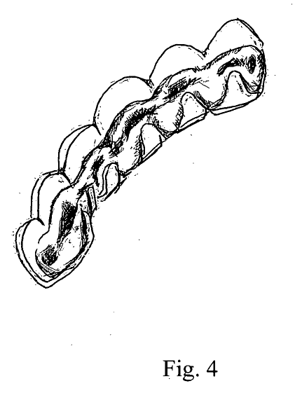

The assembly is quickly inserted into the user's mouth and the user presses the thermoplastic material to form the impressions of the intra-oral structures. The pressure is maintained for 2 to 3 minutes while the thermoplastic material sets. The assembly is then removed from the mouth and immersed in cold water to fix the impressions as illustrated in FIG. 4.

The thermoplastic material can be shaped by placing it in the mouth of a user while it is still malleable and formable and then allowing it to set by letting it cool back to room temperature. As it cools to body temperature in the mouth of the user, it hardens in the shape that it is forced into and is therefore individualized and customized to snugly fit for the user adhering to the upper and/or lower teeth.

Where the softening temperature may be uncomfortably high for insertion directly into the mouth, the mouth tissues may be pre-cooled in any suitable manner, as by first rinsing them thoroughly with ice-water before the heated member is inserted and placed about the teeth. The chilled surfaces of the mouth and teeth protect them against possible burns and will aid in quickly reducing the temperature of the impression-taking material to that at which the teeth impression becomes permanently set in the impression-taking material. The finished device will tend to cling tightly about the teeth, so that it will not be dislodged easily in use but may be readily removed and re-inserted as desired.

The invention claimed is:

1. A decorative assembly for human teeth, comprising:
an ornamental frame securing in place by tightening prongs a silicone-thermoplastic insert member that is molded with heat around a group of human teeth set and the assembly is cooled and thereafter held in the mouth by a suction effect.

2. The method of claim 1, wherein the decorative frame is secured to the teeth set by a silicone-thermoplastic material.

3. The method according to claim 2, wherein the silicone-thermoplastic material has a outer perimeter lip that provides a larger surface molding area to press into the teeth set during the heating process.

4. The decorative assembly according to claim 3, wherein the silicone-thermoplastic material does not have a perimeter lip for a greater molding surface, but all sides are perpendicular or parallel with each other.
